(19) United States
(12) Patent Application Publication
(10) Pub. No.: US 2014/0048490 A1
(43) Pub. Date: Feb. 20, 2014

(54) TREATING WASTEWATER BY ULTRAFILTRATION IN FLUOROPOLYMER RESIN MANUFACTURE

(71) Applicant: E I DU PONT DE NEMOURS AND COMPANY, Wilmington, DE (US)

(72) Inventors: ANTONIUS CORNELIS MARIA ROELEN, Breda (NL); DAVID WILLIAM JOHNSON, WASHINGTON, WV (US); WILLIAM WAYNE GOUDIE, KENNETT, PA (US)

(73) Assignee: E I DU PONT DE NEMOURS AND COMPANY, Wilmington, DE (US)

(21) Appl. No.: 13/949,276

(22) Filed: Jul. 24, 2013

Related U.S. Application Data
(60) Provisional application No. 61/684,328, filed on Aug. 17, 2012.

(51) Int. Cl. C02F 1/44

(52) U.S. Cl. CPC C02F 1/442
USPC 210/703; 210/767; 210/776; 210/808; 210/708

(57) ABSTRACT

The invention provides for a process for treating wastewater containing fluoropolymer resin waste solids comprising:
passing the wastewater through hollow fiber membranes to separate fluoropolymer resin waste solids and produce treated filtrate water; and
removing the fluoropolymer resin waste solids from the wastewater.

### FIELD OF THE INVENTION

This invention relates to a process for treating wastewater resulting from the production of fluoropolymer resin by removing waste solids using ultrafiltration membranes.

### BACKGROUND OF THE INVENTION

A typical process for the aqueous dispersion polymerization of fluorinated monomers includes feeding fluorinated monomers to a heated reactor containing fluorosurfactants and deionized water. Paraffin wax is employed in the reactor as a stabilizer for some polymerizations, e.g., polytetrafluoroethylene (PTFE) homopolymers. A free-radical initiator solution is employed and, as the polymerization proceeds, additional fluorinated monomers are added to maintain the polymerization. Wax-free polymerization is generally used for melt-processible TFE copolymers and a chain transfer agent is employed in the polymerization of some of these co-polymers to control melt viscosity. After a period of up to several hours, the feeds are stopped, the reactor is vented and the raw dispersion is transferred to holding vessel.

For use in fluoropolymer coatings applied to metals, glass and fabric, polymer dispersion is typically transferred to a dispersion stabilization and concentration operation which produces dispersions used as coatings. Certain grades of PTFE dispersion are made for the production of fine powder. For this use, the polymer dispersion is coagulated, the aqueous medium is removed and the PTFE is dried to produce fine powder. Dispersions of melt-processible fluoropolymers for molding resin use are also coagulated and the coagulated polymer is dried and then processed into a convenient form such as flake, chip or pellet for use in subsequent melt-processing operations. The manufacture of fluoropolymer resins as described generates a number of wastewater streams which contain waste polymer solids and other components, typically including some amount of fluorosurfactant.

Because of recent environmental concerns with regard to perfluorooctanoic carboxylic acids and salts (a common fluorosurfactant), there is interest in reducing or eliminating perfluoralkane carboxylic acids and salts in fluoropolymer polymerization processes and waste streams. Recently, there is an interest in using fluoroether carboxylic acids or salts as a fluorosurfactant in place of perfluoroalkane carboxylic acids or salts in the polymerization of fluoropolymers. Fluoropolymer manufacturers have also shown interest in reducing, recycling or otherwise containing fluoroether carboxylic acid or salt surfactants in fluoropolymerization processes and resulting waste streams.

Prior to removing or recovering fluorosurfactant from wastewater streams it has been necessary to either add a stabilizing surfactant to prevent solids agglomeration or remove fluoropolymer resin waste solids by precipitation in order to avoid fouling of equipment used in subsequent fluorosurfactant removal processes. Both alternatives are disclosed in US Patent Publication 2007/0027251 to Hintzer et al. With respect to adding a stabilizing surfactant, it is generally undesirable to add additional organic chemicals to any wastewater requiring treatment, particularly if the wastewater is being treated to recover fluorosurfactant. With respect to removing fluoropolymer waste solids, U.S. Pat. No. 6,613,941 to Felix et al. and US Patent Publication 2007/0027251 to Hintzer et al. disclose removing fluoropolymer particles and other fine solids from wastewater by a two-step process including precipitating fluoropolymer particles followed by separation of the precipitate. Such precipitation can be induced chemically or by electrocoagulation. Separation can be achieved by a number of known mechanical methods such as filtration, decantation, floatation or sedimentation. A simplified process for treating wastewater containing fluoropolymer resin waste solids is needed which does not require the addition of chemical agents.

### SUMMARY OF THE INVENTION

The invention provides for a process for treating wastewater containing fluoropolymer resin waste solids comprising:

passing the wastewater through hollow fiber membranes to separate fluoropolymer resin waste solids and produce treated filtrate water; and

removing the fluoropolymer resin waste solids from the wastewater.

In a preferred embodiment, the fluoropolymer resin waste solids is removed from the surface of the wastewater, preferably by skimming. In other embodiments, the wastewater contains a surfactant, preferably a fluoroether carboxylic acid or salt surfactant, which is passed through the hollow fiber membrane with the treated water filtrate. In one embodiment, the treated water filtrate is concentrated to obtain a concentrated treated water filtrate. In another embodiment, the surfactant, preferably the fluoroether carboxylic acid or salt surfactant, is recovered from the treated filtrate water.

### BRIEF DESCRIPTION OF THE DRAWINGS

FIGS. 1a-1d are schematic views of one preferred embodiment of a hollow fiber ultrafiltration membrane module used in the wastewater treatment process of this invention which produces treated filtrate water and separates fluoropolymer resin waste solids from the treated filtrate water.

FIG. 2 is a schematic of one preferred embodiment of apparatus useful for the practice of the wastewater treatment process of this invention illustrating the use of several ultrafiltration membrane modules submersed in a wastewater treatment tank and the removal of fluoropolymer resin waste solids.

### DETAILED DESCRIPTION OF THE INVENTION

### Wastewater

The present invention concerns a process for treating wastewater containing fluoropolymer resin waste solids. Wastewater is any aqueous waste stream produced during fluoropolymer resin manufacture. In addition to containing fluoropolymer resin waste solids, the wastewater may contain surfactants such as fluorsurfactants along with chemicals added to the water or generated during fluoropolymer manufacture. Dissolved salts are typically present and ionic species present may include ammonium ions, carbonates, sulfates, initiator by-products, fluorides, etc.

The wastewater may result from coagulation when PTFE fine powder or fluoropolymer molding resin is isolated from the dispersion such as by coagulation and where some small particles of fluoropolymer resin waste solids remain in the water together with possibly a portion of the fluorosurfactant. When, after polymerization, a fluoropolymer is isolated from an aqueous medium, some portion of the fluorosurfactant typically remains in the fluoropolymer. Other such wastewater streams may be generated from the washing of coagulated polymer or from the transport of coagulated polymer by water conveying processes. In another embodiment, the wastewater may be a scrubbing liquid resulting from scrubbing exhaust gas generated in the drying of fluoropolymer. When the fluoropolymer is heated for the purpose of drying, the fluorosurfactant may be volatilized and carried away in the dryer or oven exhaust gas. To avoid release of the fluorosurfactant into the environment, the exhaust gas is treated by passing it through a scrubber containing a scrubber solution to recover the fluorosurfactant from the exhaust gas stream. Hence, the scrubber solution may contain the fluorosurfactant and some fluoropolymer resin waste solids. In all of these occurrences, if there is a surfactant present that has aided in polymerization and/or stabilization it may be desirable to recover such surfactants. It is especially desirable to recover fluorosurfactant from the wastewater as will be described below. A wastewater stream may be made up of multiple streams such as those described above which originate from fluoropolymer manufacturing processes for different fluoropolymers and/or from different points in a manufacture of a single fluoropolymer.

The fluoropolymer resin waste solids are typically small fluoropolymer particles such as particles which result from dispersion polymerization, particles formed from oligomers and/or agglomerates of smaller particles. The fluoropolymer particles may have any shape although they are generally spherical and they may vary widely in size. The fluoropolymer particles typically have a number average particle size in the range of about 10 nm to about 3000 nm. Particles at the lower end of this range are typically considered to be colloidal or dispersion particles and may have a number average particle size of about 30 nm to about 500 nm, more typically about 50 nm to about 500 nm. Often particles smaller than 50 nm will agglomerate and become larger due to particle-to-particle collisions caused by turbulence in the waste water, e.g., during pumping, during the introduction of air, etc. Larger particles, e.g., particles having a size of about 500 nm to about 3000 nm in number average particle size, are typically suspended in the wastewater. Although the larger particles may be removed by using a coarse filtration step prior to treating the wastewater with ultrafiltration membranes, the process of the invention is advantageously employed to remove such particles. The quantity of fluoropolymer particles in the wastewater is generally limited and is typically less than 5% by weight fraction or less than 1% by weight fraction based on the composition of the wastewater stream with between 0.01 and 0.5% by weight fraction being common.

The present invention addresses the removal of fluoropolymer resin waste solids. The process is particularly useful in preventing such solids from interfering with wastewater discharge, especially in processes which employ subsequent surfactant removal and recovery processes, and particularly if the surfactant is a fluorosurfactant.

### Ultrafiltration

The present invention includes passing the wastewater through hollow fiber membranes to separate fluoropolymer resin waste solids and produce treated filtrate water. The hollow fibers are preferably polymeric membranes, such as polyethersulfones or polyvinylidene fluoride, having an outside diameter of about 1.5 mm to about 5.0 mm, preferably about 1.5 mm to about 3.0 mm. The membranes preferably have a high mechanical strength due to reinforcement such as a textile braid provided inside the membranes. The fibers preferably have a length of 1000 mm-2700 mm, e.g., 1800 mm long, and preferably are arranged in bundles. A typical effective surface area of a bundle can be approximately 3.3 m².

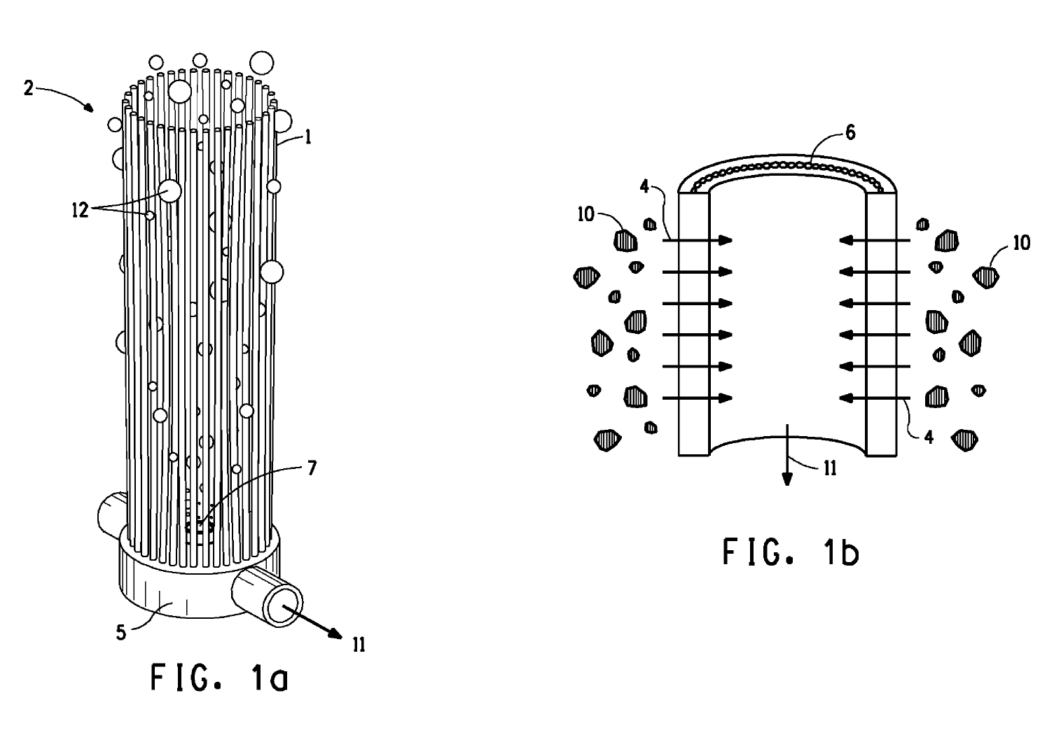

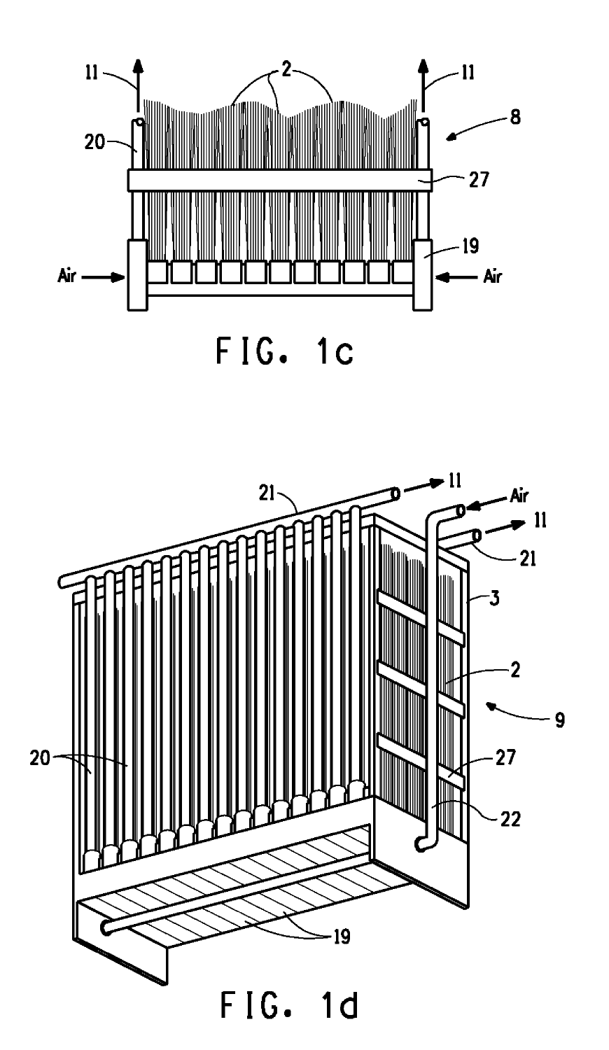

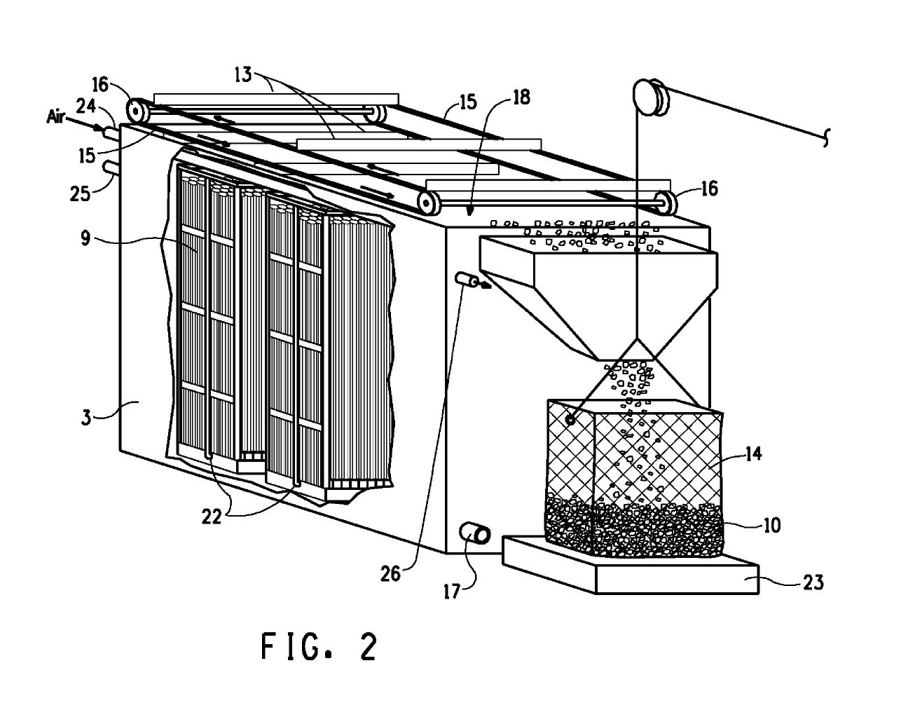

The hollow fiber membranes preferably have a pore size from about 0.03 to about 0.07 μm, preferably about 0.05 μm (50 nanometers). For illustration, a preferred membrane system, such as that available from Puron® Hollow Fiber Modules produced by Koch Membrane Systems, Inc. of Wilmington, Mass. is described in FIGS. 1a-1d along with modifications for this invention shown in FIG. 2. As shown in FIG. 1a, hollow fiber membranes (1) used in this invention are preferably arranged in circular bundles (2). Each bundle in the system soled by Koch Membranes Systems has an effective area of approximately 3.3 m². As shown in FIG. 2, the bundles (2) are preferably submerged vertically in a tank (3) containing wastewater. In the preferred system shown, the tank (3) can be filled with wastewater through wastewater inlet (25) to provide an exposed upper surface (18) of the wastewater. As shown in FIG. 1a, the lower ends of the hollow membrane fibers are preferably secured by a bottom header (5) while the upper ends are individually sealed. An air nozzle (7) is preferably located in the bottom header (5) at the center of the membrane bundles (2) and provides for air scouring as will be described in more detail hereinafter. As shown in FIG. 1b, the preferred membranes sold by Koch Membrane Systems include a braided reinforcement (6) embedded within the membrane which provides mechanical strength and integrity to the hollow fiber.

In the preferred membrane system sold by Koch Membrane Systems, the bottom header (5) for a plurality of bundles (2) of hollow fiber membranes is provided by a tray (19) which supports the bundles (2) of hollow fiber membranes in a row (8) as shown in FIG. 1c. A number of trays (19) are supported by a frame (3) to provide a module (9) as shown in FIG. 1d. The trays (19) include interior passages (not shown) which provide liquid flow from the lower ends of the hollow fiber membranes and passages (not shown) to supply air flow to the nozzle (7). The bundles (2) of hollow fiber membranes for each row (8) are supported loosely by support (27) which allows the upper ends of the hollow membranes freedom to move laterally. This freedom of movement aids in the scouring action of the air bubbles (12) as will be described below. In an alternate embodiment, air flow may be provided external to the bundle providing a similar air scouring function on the membrane surface.

As shown in FIGS. 1c and 1d, each tray (19) includes a filtrate riser (20) which connects to the interior passages in fluid communication with the lower ends of the bundles (2) of hollow fiber membranes. In a module (9), the filtrate risers are connect to a filtrate manifold (21) positioned near the top of the module. In a preferred membrane system which employs a number of modules (9) in the tank (3) such as the two modules (9) shown in FIG. 2, the filtrate manifolds (21) of the modules are connected by appropriate piping (not shown) to filtrate outlet (26). Each module (9) in the preferred system also includes an air line (22) which extends from the top of the module and is in fluid communication with the passages in the trays (19) which supply air flow to the nozzle (7) for each bundle (2) of hollow fiber membranes. When multiple modules are used as in FIG. 2, air may be supplied to inlet (24) which is connected to the air lines (22) of each module. Although not shown, the tank (3) is provided with a cover to prevent vapors of fluorosurfactant from escaping and to prevent dust of the fluoropolymer resin waste solids from entering the environment.

Dual header membranes such as modules of ZeeWeed® membranes provided by GE Water & Process Technologies with headquarters in Trevose, Pa., may be also used provided there is a means for removal of the fluoropolymer resin waste solids such as by floatation or precipitation. Such membranes typically having a pore size of about 40 nm and outside diameter of about 1.9 mm. The single header membrane system described above has the advantage of more freedom of hollow fiber movement which reduces the rate of membrane fouling as compared to a dual header system.

By applying subatmospheric pressure to filtrate outlet (26), wastewater is preferably passed through the hollow fiber membranes (1) in each module (9) so that fluoropolymer resin waste solids (10) remains outside of the membrane and treated filtrate water indicated by arrow (11) flows through to the inside of the hollow fiber membrane. The treated filtrate water (11) in the preferred system flows down the inside of the fibers to the bottom header (5), though the passages in the trays (19), up the filtrate risers (20) and into the filtrate manifolds (21) to the filtrate outlet (26). As will be explained later, surfactant if present, especially fluorosurfactant, for example a fluoroether carboxylic acid or salt surfactant, is passed through the hollow fiber membrane with the treated water filtrate while the fluoropolymer resin waste solids (10) having particle sizes larger than the membrane pores are separated from the treated water filtrate (11). The treated filtrate from the filtrate outlet (26) may then be further treated as desired such as removing or recovering surfactant. By supplying pressurized air to inlet (24), air is supplied to air nozzles (7). Referring again to FIG. 1a, air bubbles (12) rise from the air nozzle (7) and scour the membrane surface preventing fluoropolymer solids from accumulating on the membrane surface and keeping the membrane surface free of solids buildup.

Unlike municipal sludge treatment that uses similar membrane modules where heavy waste solids sink to the bottom of the wastewater treatment tank, the hydrophobic fluoropolymer resin wastewater particles preferably capture a portion of the hydrophobic air bubbles supplied from air nozzles (7) becoming buoyant and float to the surface of the wastewater tank where they are removed from the wastewater as will be described below. In this way air flow into the wastewater from air nozzles (7) preferably aids in moving the fluoropolymer waste solids (10) from outside the membrane to the surface of the wastewater where it can be removed. In the event that any fluoropolymer resin waste solids settle at the bottom of the tank, such solids are conventionally removed by drawing off water or sludge at drain (17) shown in FIG. 2 and dewatering. The water or sludge removed may contain fluoropolymer resin waste particles and other solid particles, e.g. filter media, if the waste stream has been subjected to coarse filtration prior to ultrafiltration.

Wastewater is typically drawn through the hollow membranes at a flow rate ranging from about 2 to about 45 l/m2.hr at pressures ranging from about 0 to about 1 bar transmembrane pressure. This slow rate of flux also aids in minimizing the build-up of solids on the membrane surface. The process preferably produces treated filtrate water which is substantially free of fluoropolymer resin, that is, the treated filtrate water preferably contains less than 300 ppm, more preferably less than 100 ppm, most preferably less than 50 ppm fluoropolymer resin by weight based on the amount of water filtrate. Treated filtrate water preferably has a water turbidity of 0.1-0.9 NTU, more preferably 0.2-0.4 NTU as determined with a Hach Turbiditimeter, Model 2100N (Loveland, Colo.).

In a preferred embodiment the pH of the wastewater stream fed to the ultrafiltration membrane is less than about 5, preferably in a range of about 3 to about 5. Acidification of the wastewater stream promotes the coagulation of the waste solids in the wastewater processing tank. Further acidification promotes the conversion of carbonate ions in the wastewater to carbon dioxide gas resulting in increased adsorption when carbon beds are used for fluorosurfactant removal as discussed hereinafter.

The process of wastewater treatment of this invention preferably involves the following cycles of the ultrafiltration system as will be described more fully in the Examples:
Aeration—Air blower is cycled to aid in fluoropolymer resin waste solids removal. (In some embodiments, it may be preferable to blow air in each or in all steps except for the relaxation step.)
Vacuum—Vacuum pressure is cycled to pull wastewater through the membrane. Pressure between 0 and 1 bar transmembrane pressure.
Backwash—Vacuum is reversed and cycled to aid in the cleaning of the membrane. Pressure between 0 and 1 bar transmembrane pressure.
De-aeration—Dearation is used to remove air/gas in pockets inside the UF membranes. It is done by pulling an increased flow of wastewater through the membranes.
Scrubbing/Relaxation—Air is fed to the system but no vacuum is applied and therefore no wastewater flows through the hollow membranes. Including this optional step prolongs membrane life by reducing fouling.
Draining/removal—No air is fed to the system, and the water level is raised. Skimming takes place. After skimming the membrane tank is partially drained.

### Waste Solids Removal

The present invention includes removing fluoropolymer resin waste solids from wastewater, preferably from the surface of the wastewater. Such removal can be achieved manually such as by scooping or with mechanical assistance or by assistance from an air stream or water stream. In a preferred process fluoropolymer resin waste solids is removed by skimming the solids from the surface of the wastewater. A preferred embodiment for removing fluoropolymer resin waste solids is as shown in FIG. 2 by using a paddle assembly which includes paddles (13) that extend across the top of the tank (3) containing the wastewater and are supported to extend into the water above the submerged hollow membrane module (9) to skim the surface of the wastewater (18). Paddles (13) are preferably supported for skimming movement by a chain drive system which includes two chains (15) which connect to the paddles (13) adjacent their ends. The chains ride on sprockets (16) which driven by motor drive (not shown) to move the chains in the indicated direction. As illustrated, it is desirable to use a small number of paddles to provide enough spacing between paddles in the paddle assembly to allow for the removal of a membrane module (9) though the space between paddles without having to disassemble or remove the paddle assembly. In a preferred manufacturing setting, the fluoropolymer resin waste solids (10), also referred to as fluff because of its fine particle nature and low bulk density, is skimmed and deposited into a filter bag (14), such as a Dewatering Super Sack® supplied by B.A.G. Corp. (Dallas, Tex.) or a Dewatering Bag supplied by Greif (Moerdijk, the Netherlands) to allow the water to drain such as into drain pan (23) before disposing of the waste solids.

In one embodiment, for effective skimming, the water level in the tank is raised, the air flow device is turned off and the removal of treated water filtrate is stopped. With the system in this state, the fluoropolymer waste solids may be periodically removed from the wastewater such as by skimming using the preferred apparatus described above. Typically in a fluoropolymer manufacturing plant operation which periodically removes waste solids, the solids may be skimmed for about 1 minute to 30 minutes before resuming the ultrafiltration treatment operation. Alternatively, this invention advantageously allows for the continuous removal of fluoropolymer waste resin solids at the surface of the tank without interfering with the ultrafiltration membrane separation process. In such a continuous process, the solids removal would be done such as by slow skimming when using the paddle assembly described above.

### Fluoropolymer

Fluoropolymer resins are produced by polymerizing fluoromonomers in an aqueous medium to form aqueous fluoropolymer dispersion. The fluoropolymer is made from at least one fluorinated monomer (fluoromonomer), i.e., wherein at least one of the monomers contains fluorine, preferably an olefinic monomer with at least one fluorine or a fluoroalkyl group attached to a doubly-bonded carbon. The fluorinated monomer and the fluoropolymer obtained therefrom each preferably contain at least 35 wt % F, preferably at least 50 wt % F and the fluorinated monomer is preferably independently selected from the group consisting of tetrafluoroethylene (TFE), hexafluoropropylene (HFP), chlorotrifluoroethylene (CTFE), trifluoroethylene, hexafluoroisobutylene, perfluoroalkyl ethylene, fluorovinyl ethers, vinyl fluoride (VF), vinylidene fluoride (VF2), perfluoro-2,2-dimethyl-1,3-dioxole (PDD), perfluoro-2-methylene-4-methyl-1,3-dioxolane (PMD), perfluoro(allyl vinyl ether) and perfluoro(butenyl vinyl ether) and mixtures thereof. A preferred perfluoroalkyl ethylene monomer is perfluorobutyl ethylene (PFBE). Preferred fluorovinyl ethers include perfluoro (alkyl vinyl ether) monomers (PAVE) such as perfluoro(propyl vinyl ether) (PPVE), perfluoro(ethyl vinyl ether) (PEVE), and perfluoro(methyl vinyl ether) (PMVE). Non-fluorinated olefinic comonomers such as ethylene and propylene can be copolymerized with fluorinated monomers.

Fluorovinyl ethers also include those useful for introducing functionality into fluoropolymers. These include CF₂═CF—(O—CF₂CFR_{f})ₐ—O—CF₂CFR′_{f}SO₂F, wherein R_{f} and R′_{f} are independently selected from F, Cl or a perfluorinated alkyl group having 1 to 10 carbon atoms, a=0, 1 or 2. Polymers of this type are disclosed in U.S. Pat. No. 3,282,875 (CF₂═CF—O—CF₂CF(CF₃)—O—CF₂CF₂SO₂F, perfluoro(3,6-dioxa-4-methyl-7-octenesulfonyl fluoride)), and in U.S. Pat. Nos. 4,358,545 and 4,940,525 (CF₂═CF—O—CF₂CF₂SO₂F). Another example is CF₂═CF—O—CF₂—CF(CF₃)—O—CF₂CF₂CO₂CH₃, methyl ester of perfluoro(4,7-dioxa-5-methyl-8-nonenecarboxylic acid), disclosed in U.S. Pat. No. 4,552,631. Similar fluorovinyl ethers with functionality of nitrile, cyanate, carbamate, and phosphonic acid are disclosed in U.S. Pat. Nos. 5,637,748; 6,300,445; and 6,177,196.

The process of this invention is useful for a preferred class of fluoropolymers of perfluoropolymers in which the monovalent substituents on the carbon atoms forming the chain or backbone of the polymer are all fluorine atoms, with the possible exception of comonomer, end groups, or pendant group structure. Preferably the comonomer, end group, or pendant group structure will impart no more than 2 wt % C—H moiety, more preferably no greater than 1 wt % C—H moiety, with respect to the total weight of the perfluoropolymer. Preferably, the hydrogen content, if any, of the perfluoropolymer is no greater than 0.2 wt %, based on the total weight of the perfluoropolymer.

Especially useful are fluoropolymers of polytetrafluoroethylene (PTFE) including modified PTFE. Polytetrafluoroethylene (PTFE) refers to (a) the polymerized tetrafluoroethylene by itself without any significant comonomer present, i.e. homopolymer and (b) modified PTFE, which is a copolymer of TFE having such small concentrations of comonomer that the melting point of the resultant polymer is not substantially reduced below that of PTFE. The modified PTFE contains a small amount of comonomer modifier which reduces crystallinity to improve film forming capability during baking (fusing). Examples of such monomers include perfluoroolefin, notably hexafluoropropylene (HFP) or perfluoro(alkyl vinyl ether) (PAVE), where the alkyl group contains 1 to 5 carbon atoms, with perfluoro(ethyl vinyl ether) (PEVE) and perfluoro(propyl vinyl ether) (PPVE) being preferred, chlorotrifluoroethylene (CTFE), perfluorobutyl ethylene (PFBE), or other monomer that introduces bulky side groups into the polymer molecule. The concentration of such comonomer is preferably less than 1 wt %, more preferably less than 0.5 wt %, based on the total weight of the TFE and comonomer incorporated in the PTFE. A minimum amount of at least about 0.05 wt % is preferably used to have significant effect. PTFE (and modified PTFE) typically have a melt creep viscosity of at least about 1×10⁶ Pa·s and preferably at least 1×10⁸ Pa·s and, with such high melt viscosity, the polymer does not flow in the molten state and therefore is not a melt-processible polymer. The measurement of melt creep viscosity is disclosed in col. 4 of U.S. Pat. No. 7,763,680. The high melt viscosity of PTFE arises from is extremely high molecular weight (Mn), e.g. at least 10⁶. PTFE can also be characterized by its high melting temperature, of at least 330° C., upon first heating. The non-melt flowability of the PTFE, arising from its extremely high melt viscosity, results in a no melt flow condition when melt flow rate (MFR) is measured in accordance with ASTM D 1238 at 372° C. and using a 5 kg weight, i.e., MFR is 0. The high molecular weight of PTFE is characterized by measuring its standard specific gravity (SSG). The SSG measurement procedure (ASTM D 4894, also described in U.S. Pat. No. 4,036,802) includes sintering of the SSG sample free standing (without containment) above its melting temperature without change in dimension of the SSG sample. The SSG sample does not flow during the sintering.

The process of the present invention is also useful for low molecular weight PTFE, which is commonly known as PTFE micropowder, so as to distinguish from the PTFE described above. The molecular weight of PTFE micropowder is low relative to PTFE, i.e. the molecular weight (Mn) is generally in the range of 10⁴ to 10⁵. The result of this lower molecular weight of PTFE micropowder is that it has fluidity in the molten state, in contrast to PTFE which is not melt flowable. PTFE micropowder has melt flowability, which can be characterized by a melt flow rate (MFR) of at least 0.01 g/10 min, preferably at least 0.1 g/10 min and more preferably at least 5 g/10 min, and still more preferably at least 10 g/10 min., as measured in accordance with ASTM D 1238, at 372° C. using a 5 kg weight on the molten polymer.

The process of this invention is especially useful for melt-processible fluoropolymers that are also melt-fabricable. Melt-processible means that the fluoropolymer can be processed in the molten state, i.e., fabricated from the melt using conventional processing equipment such as extruders and injection molding machines, into shaped articles such as films, fibers, and tubes. Melt-fabricable means that the resultant fabricated articles exhibit sufficient strength and toughness to be useful for their intended purpose. This sufficient strength may be characterized by the fluoropolymer by itself exhibiting an MIT Flex Life of at least 1000 cycles, preferably at least 2000 cycles, measured as disclosed in U.S. Pat. No. 5,703,185. The strength of the fluoropolymer is indicated by it not being brittle.

Examples of such melt-processible fluoropolymers include homopolymers such as polychlorotrifluoroethylene and polyvinylidene fluoride (PVDF) or copolymers of tetrafluoroethylene (TFE) and at least one fluorinated copolymerizable monomer (comonomer) present in the polymer usually in sufficient amount to reduce the melting point of the copolymer substantially below that of PTFE, e.g., to a melting temperature no greater than 315° C.

A melt-processible TFE copolymer typically incorporates an amount of comonomer into the copolymer in order to provide a copolymer which has a melt flow rate (MFR) of 0.1 to 200 g/10 min as measured according to ASTM D-1238 using a 5 kg weight on the molten polymer and the melt temperature which is standard for the specific copolymer. MFR will preferably range from 1 to 100 g/10 min, most preferably about 1 to about 50 g/10 min. Additional melt-processible fluoropolymers are the copolymers of ethylene (E) or propylene (P) with TFE or CTFE, notably ETFE and ECTFE.

A preferred melt-processible copolymer for use in the practice of the present invention comprises at least 40-99 mol % tetrafluoroethylene units and 1-60 mol % of at least one other monomer. Additional melt-processible copolymers are those containing 60-99 mol % PTFE units and 1-40 mol % of at least one other monomer. Preferred comonomers with TFE to form perfluoropolymers are perfluoromonomers, preferably perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers are those in which the alkyl group contains 1, 2, 3 or 4 carbon atoms, and the copolymer can be made using several PAVE monomers. Preferred TFE copolymers include FEP (TFE/HFP copolymer), PFA (TFE/PAVE copolymer), TFE/HFP/PAVE wherein PAVE is PEVE and/or PPVE, MFA (TFE/PMVE/PAVE wherein the alkyl group of PAVE has at least two carbon atoms) and THV (TFE/HFP/VF₂).

All these melt-processible fluoropolymers can be characterized by MFR as recited above for the melt-processible TFE copolymers, i.e. by the procedure of ASTM 1238 using standard conditions for the particular polymer, including a 5 kg weight on the molten polymer in the plastometer for the MFR determination of PFA and FEP

The process of this invention is further useful for polymers that are film forming polymers of polyvinylidene fluoride (PVDF) and copolymers of vinylidene fluoride as well as polyvinyl fluoride (PVF) and copolymers of vinyl fluoride.

The process of this invention is also useful for fluorocarbon elastomers (fluoroelastomers). These elastomers typically have a glass transition temperature below 25° C. and exhibit little or no crystallinity at room temperature and little or no melting temperature. Fluoroelastomer made by the process of this invention typically are copolymers containing 25 to 75 wt %, based on total weight of the fluoroelastomer, of copolymerized units of a first fluorinated monomer which may be vinylidene fluoride (VF₂) or tetrafluoroethylene (TFE). The remaining units in the fluoroelastomers are comprised of one or more additional copolymerized monomers, different from the first monomer, selected from the group consisting of fluorinated monomers, hydrocarbon olefins and mixtures thereof. Fluoroelastomers may also, optionally, comprise units of one or more cure site monomers. When present, copolymerized cure site monomers are typically present at a level of 0.05 to 7 wt %, based on total weight of fluorocarbon elastomer. Examples of suitable cure site monomers include: i) bromine-, iodine-, or chlorine-containing fluorinated olefins or fluorinated vinyl ethers; ii) nitrile group-containing fluorinated olefins or fluorinated vinyl ethers; iii) perfluoro(2-phenoxypropyl vinyl ether); and iv) non-conjugated dienes.

Preferred TFE based fluoroelastomer copolymers include TFE/PMVE, TFE/PMVE/E, TFE/P and TFE/P/VF₂. Preferred VF₂ based fluorocarbon elastomer copolymers include VF₂/HFP, VF₂/HFP/TFE, and VF₂/PMVE/TFE. Any of these elastomer copolymers may further comprise units of cure site monomer.

Aqueous dispersion polymerization of fluorinated monomer typically includes feeding fluorinated monomer to a heated reactor containing a fluorosurfactant and deionized water. A free-radical initiator solution is employed and, as the polymerization proceeds, additional fluorinated monomer is added to maintain the pressure. Paraffin wax may be used as a stabilizer for some polymerizations, such as PTFE type polymers. Chain transfer agent is employed in the polymerization of some polymers, e.g., melt-processible TFE copolymers to control melt viscosity. After several hours, the feeds are stopped, the reactor is vented and the raw dispersion is transferred to holding vessel.

### Surfactants

Surfactants whether polymerization aids and/or stabilization aids used in fluoropolymer manufacture may be present in wastewater containing fluoropolymer resin waste solids. These surfactants may be fluorosurfactants. The surfactants if present in the wastewater are passed through the hollow fiber membrane with the treated water filtrate. The surfactants may be removed or recovered from the wastewater as will be explained in the discussion below and as exemplified with fluoroether carboxylic acid or salt surfactant.

Fluorosurfactants are typically used as a polymerization aid in the dispersion polymerization of fluoropolymers, the fluorosurfactants functioning primarily as a non-telogenic dispersing agent. For example, an early description of the use of ammonium perfluorooctanoate as fluorosurfactant is found in U.S. Pat. No. 2,559,752 (Berry). Because of recent environmental concerns with regard to perfluorooctanoic carboxylic acid and salts, there is interest in reducing or eliminating perfluorooctanoic carboxylic acid and salts in fluoropolymer polymerization processes and waste streams. Recently, there is an interest in using fluoroether carboxylic acids or salts as a fluorosurfactant in place of perfluoroalkane carboxylic acids or salts in the polymerization of fluoropolymers. Fluoropolymer manufacturers have also shown interest in reducing, recycling or otherwise containing fluoroether carboxylic acid surfactant in fluoropolymerization processes and resulting waste streams.

Examples of suitable fluoroether surfactants have been described in U.S. Pat. No. 3,271,341 to Garrison; U.S. patent publications 2007/0015864, 2007/0015865, and 2007/0015866 to Hintzer et al.; U.S. patent publications 2005/0090613 to Maruya et al. and 2006/0281946 to Morita et al.; PCT patent publications WO 2007046345 to Higuchi et al., 2007046377 to Funaki et al., 2007046482 to Hoshikawa et al., and 2007/049517 to Matsuoka et al. Additional fluorosurfactants are disclosed in U.S. Pat. No. 7,705,074 (Brothers et al.), which are the combination of a fluoropolyether having a number average molecular weight of at least 800 g/mol and a short chain fluorosurfactant having the formula

[R¹—Oₙ-L-A⁻]Y⁺ (I)

wherein:
R¹ is a linear or branched partially or fully fluorinated aliphatic group which may contain ether linkages;
n is 0 or 1;
L is a linear or branched alkylene group which may be nonfluorinated, partially fluorinated or fully fluorinated and which may contain ether linkages;
A⁻ is an anionic group selected from the group consisting of carboxylate, sulfonate, sulfonamide anion, and phosphonate; and
Y⁺ is hydrogen, ammonium or alkali metal cation; with the proviso that the chain length of R¹—Oₙ-L- is not greater than 6 atoms.

“Chain length” as used in this application refers to the number of atoms in the longest linear chain in the hydrophobic tail of the fluorosurfactant employed in the process of this invention. Chain length includes atoms such as oxygen atoms in addition to carbon in the chain of hydrophobic tail of the surfactant but does not include branches off of the longest linear chain or include atoms of the anionic group, e.g., does not include the carbon in carboxylate. “Short chain” as used in this application refers to a chain length of not greater than 6. “Long chain” refers to a chain length of greater than 6, e.g., fluorosurfactants having a chain length of 7 to 14 atoms.

Preferably, the chain length of R¹—Oₙ-L- is 3 to 6 atoms. In accordance with one preferred form of the invention the chain length of R¹—Oₙ-L- is 4 to 6 atoms. In accordance with another preferred form of the invention the chain length of R¹—Oₙ-L- is 3 to 5 atoms. Most preferably, the chain length of R¹—Oₙ-L- is 4 to 5 atoms.

The preferred short chain surfactant is the dimer acid of hexafluoropropylene epoxide, having the formula C₃F₇O—CF(CF₃)—COOH.

The perfluoropolyether (PFPE) acids or salts thereof can have any chain structure in which oxygen atoms in the backbone of the molecule are separated by saturated fluorocarbon groups having 1-3 carbon atoms. More than one type of fluorocarbon group may be present in the molecule. Representative structures have the repeat unit represented in the following formulas:

(—CFCF₃—CF₂—O—)ₙ (VII)

(—CF₂—CF₂—CF₂—O—)ₙ (VIII)

(—CF₂—CF₂—O—)ₙ—(—CF₂—O—)ₘ (IX)

(—CF₂—CFCF₃—O—)ₙ—(—CF₂—O—)ₘ (X)

These structures are discussed by Kasai in J. Appl. Polymer Sci. 57, 797 (1995). As disclosed therein, such PFPE can have a carboxylic acid group or salt thereof at one end or at both ends. Similarly, such PFPE may have a sulfonic acid or phosphonic acid group or salt thereof at one end or both ends.

As a class, the perfluoroether carboxylic acids and salts have a greater affinity for water making recovery from wastewater streams more attractive economically than perfluorooctanoic carboxylic acids and salts. Thus in fluoropolymer resin manufacturing processes, it has been found that a certain portion of the low molecular weight fluoroether carboxylic acid or salt surfactant remains in the wastewater. In a preferred embodiment of this invention, the wastewater contains a fluoroether carboxylic acid or salt surfactant which is passed through the hollow fiber membrane with the treated water filtrate. The treated water filtrate may then be subjected to any number of fluorosurfactant removal processes. In one embodiment, the treated water filtrate may be contacted with an anion-exchange resin to remove fluoroether carboxylic acid or salt surfactant as described U.S. Pat. No. 6,613,941 B1 to Felix et al. In another embodiment, the treated water filtrate may be contacted with other adsorbent particles such as activated carbon, silica gel, clays and zeolites as disclosed in US Publication 2005/000904 to Le Bec and US Publication 2007/0027251 to Hintzer et al. In another embodiment, the treated water filtrate is further concentrated using membrane separation techniques such as employing reverse osmosis membranes or nanofiltration membranes in order to obtain a concentrated treated water filtrate. Preferably, the concentration of fluoroether carboxylic acid or salt surfactant is increased to about 10%, more preferably to about 15%, and most preferably to about 20%. Membranes having a pore size from about 0.0001-0.008 micrometers may be used in this concentration process. Reverse osmosis membranes generally have a pore size ranging from about 0.0001 to about 0.0015 micrometers. Nanofiltration membranes generally have a pore size ranging from about 0.0009 to about 0.008 micrometers. In a preferred embodiment of the process of this invention, nanofiltration membranes are used to obtain a concentrated water filtrate. In one embodiment of this invention, nanofiltration membranes used to obtain a concentrated treated water filtrate have a pore size ranging from 0.004 to about 0.006 micrometers.

In another embodiment, an adsorption treatment such as a treatment employing activated carbon may be combined with the membrane separation concentration. After concentrating the treated water filtrate using membrane separation, the fluoroether carboxylic acid or salt surfactant remaining in the permeated liquid may be reduced by the adsorption with activated carbon. Particularly when the permeated liquid is discarded outside the system, it is effective that the disposal is conducted after subjecting the liquid to the adsorption treatment with activated carbon.

In yet another embodiment, the concentrate obtained by the filtration treatment using membrane separation is recovered for reuse. The concentrate may be subjected to a purification treatment step so as to obtain the fluoroether carboxylic acid or salt surfactant with a high purity. For example, when an acid (for example sulfuric acid) is added to the concentrate which contains the fluoroether carboxylic acid or salt surfactant in a salt form and in which the concentration of the surfactant is increased to 10 mass % by the filtration treatment, the salt is transformed into its acid form whose solubility in water is low, whereby the fluoroether carboxylic acid or salt surfactant is separated as an organic phase from the filtrate water and then recovered. As a result, the decantate of high purity which contains the fluoroether carboxylic acid or salt surfactant in an amount of 85 mass % (the rest is substantially water) can be obtained. The decantate is distilled by heating (preferably under a reduced pressure) to evaporate and remove the water firstly, and further heated to obtain the fluoroether carboxylic acid or salt surfactant in an acid form as a distillate, whereby the fluoroether carboxylic acid or salt surfactant with a purity of 96% or more can be recovered. In summary, the concentrated treated water filtrate may be subjected to a purification step which consists of adding an acid (for example, adding sulfuric acid), separating a decantate, and distilling the decantate. A purification system similar to that described in U.S. Pat. Nos. 6,437,159 and 6,281,374, both to Schulz, may be used.

The fluoroether carboxylic acid may be used in acid form or neutralized as salt for use as a surfactant for any appropriate application, just as it is or after an additional treatment, for example, the surfactant can be used as the dispersing agent again in the polymerization of a fluoromonomer. The selection of membrane pore size for the concentration of the fluoroether carboxylic acid or salt surfactant is made with consideration to the transport rate of the surfactant or any other salts or gases of interest in the wastewater stream. Reverse osmosis membranes which generally have smaller pores are commonly used to separate out ionic species with the objective of obtaining pure water. It has been found that nanofiltration membranes which have somewhat larger pores provide good permeate flux rates, permitting the passage of smaller ionic species (mostly the small monovalent ions and gases like ammonia and carbon dioxide) but retaining approximately 99% of the fluoroether carboxylic acid or salt surfactant in the concentrate. When fluoroether carboxylic acid or salt surfactant is used for the polymerization of fluorinated monomer, the wastewater typically contains fluoroether carboxylic acid or salt surfactant in amount of not more than 5% by weight, preferably not more than 1.5% by weight. In other embodiments, wastewater may have an amount of fluoroether carboxylic acid or salt between about 1 ppm and about 3000 ppm, preferably between about 50 ppm and about 3000 ppm.

### PROCESS EXAMPLE

Wastewater from a process for the aqueous dispersion polymerization of fluorinated monomer wherein the stream contains fluoropolymer resin waste solids and fluoroether carboxylic acid or salt surfactant along with other salts is fed from two 60 m³ feed tanks to an ultrafiltration system that includes two ultrafiltration units in parallel design to handle a split flows at a total peak flow of 15 m³/hr. Each ultrafiltration unit is of the type shown in FIGS. 1a-1d and FIG. 2 and each includes membrane modules submerged vertically in a wastewater processing tank having a capacity of 12 m³. The two feed tanks provide a hold-up capacity upstream of the ultrafiltration system. Another 12 m³ gallon tank is located downstream of the ultrafiltration system for use a backwash and buffer for the nanofiltration membrane separation unit that follows. Prior to being fed to the ultrafiltration system, the wastewater stream is treated with HCl to achieve of pH of between 3.5 and 4.0.

Each ultrafiltration unit is designed for independent and simultaneous operation. Each unit is designed to operate at a flux of 10 l/hr.m2 for normal flow and at a flux of 20 l/hr.m² for short periods to serve as catch up capacity and cover for downtime on the sister unit. The two membrane system units are available from Puron® Hollow Fiber Modules produced by Koch Membrane Systems, Inc. Each unit consists of three 250 m² membrane modules from Koch Puron for a combined total of 1500 m² of membranes with hollow fiber membrane pore size about 0.05 micrometers (50 nanometers). Individual fiber membranes have an outside diameter of 0.1 inch (2.6 mm) and an inside diameter of approximately 0.05 inch (1.4 mm). The wastewater is pulled through the membrane by vacuum. The flow is fixed to the desired level of and is adjusted by monitoring the vacuum to achieve the desired flow. The wastewater is drawn through the hollow fiber membrane at an absolute pressure of approximately 0.5 bar so that fluoropolymer resin waste solids remains outside of the membrane and treated filtrate water flows through to the inside of the hollow fiber membrane. The treated filtrate water flows down the inside of the fibers to the bottom header. Aeration as discussed above provides for air scouring. Air bubbles rise from the air nozzle located in the center of the membrane bubbles and scour the membrane surface keeping the membrane surface free of solids buildup. The fluoropolymer resin wastewater solids are buoyant and float to the surface of the wastewater tank with the assistance of the air flow. The vacuum pump has the capability of reverse flow. A backwash using treated filtrate water is done at a certain frequency to help clean the membranes.

In this example the following cycles are advantageously employed to carry out the invention.

Aeration—65 seconds on 65 seconds off @ 150 Nm³/hr

Vacuum—12 minutes @ 7.5 m³/hr

Backwash—30 seconds every 12 minutes @ 22.5 m3/hr

De-aeration—90 seconds every 6 hours @ 22.5 m³/hr

Scrubbing/Relaxation—30 minutes every 6 hours

Skimming—2 minutes every 3 days

Each unit is equipped with skimming capability in the form of a paddle system as explained above in order to remove the fluoropolymer resin waste solids from the surface of the wastewater. The skimmed solids are dewatered and deposited into a filter bag, Dewatering Big Bag® supplied by Greif (Moerdijk, the Netherlands), which allows the water to drain before disposing of the waste solids. A basin is provided to capture overflows and water from the dewatering stage. A vent system is also provided to capture and redirect vapors generated from the treatment operation. Each unit has the capability for tank flushes to remove sludge build up from the bottom of the wastewater processing tank.

The treated water filtrate has a fluoropolymer resin waste solids content of less than about 50 ppm with a turbidity less than 1 NTU determined using a Hach Turbiditimeter Model 2100N (Loveland, Colo.). The treated water filtrate has a fluoroether carboxylic acid or salt surfactant content of approximately 200-300 ppm. The treated water filtrate is pumped to multiple nanofiltration units having membranes with pore sizes between 0.004 and 0.006 micrometers for concentration of the treated water filtrate to recover a concentrated fluoroether carboxylic acid or salt surfactant solution. The filtrate (permeate) produced by the nanofiltration units contains low levels of surfactant that can be removed using an activated carbon bed. After multiple stages of concentration using nanofiltration treatment, the concentrated fluoroether carboxylic acid or salt solution recovered has fluoroether carboxylic acid or salt surfactant content of approximately 20%.

What is claimed is:

1. A process for treating wastewater containing fluoropolymer resin waste solids comprising:
passing the wastewater through hollow fiber membranes to separate fluoropolymer resin waste solids and produce treated filtrate water; and
removing the fluoropolymer resin waste solids from the wastewater.

2. The process of claim 1 wherein said wastewater is contained in a tank providing an upper exposed surface of the wastewater.

3. The process of claim 2 wherein the fluoropolymer resin waste solids are removed from the surface of the wastewater.

4. The process of claim 3 wherein fluoropolymer resin waste solids is removed by skimming the solids from the surface of the wastewater.

5. The process of claim 1 wherein the treated filtrate water is substantially free of fluoropolymer resin.

6. The process of claim 1 wherein the wastewater is passed through the hollow fiber membrane so that waste solids remains outside of the membrane and treated filtrate water flows through to the inside of the hollow fiber membrane.

7. The process of claim 6 wherein air flow into the wastewater aids in moving the fluoropolymer waste solids from outside the membrane to the surface of the wastewater.

8. The process of claim 1 wherein the passing of the wastewater through the hollow fiber membranes is assisted by lower pressure inside the hollow fiber membrane than outside.

9. The process of claim 1 wherein the wastewater is passed through the membrane at a flow rate ranging from about 2 to about 45 l/m²·hr.

10. The process of claim 1 wherein the length of the hollow fibers range from about 1000 mm to about 2700 mm.

11. The process of claim 1 wherein the pore size of the hollow fibers range from about 0.03 to about 0.07 μm.

12. The process of claim 1 wherein the wastewater contains a surfactant which is passed through the hollow fiber membrane with the treated water filtrate.

13. The process of claim 1 wherein the wastewater contains a fluoroether carboxylic acid or salt surfactant which is passed through the hollow fiber membrane with the treated water filtrate.

14. The process of claim 13 wherein the treated water filtrate is concentrated to obtain a concentrated treated water filtrate.

15. The process of claim 13 wherein the fluoroether carboxylic acid or salt surfactant is recovered from the treated water filtrate.

16. The process of claim 1 wherein the fluoropolymer waste solids is periodically removed from the wastewater.

17. The process of claim 14 wherein the treated water filtrate is concentrated by membrane separation.

18. The process of claim 17 wherein the membrane separation is nanofiltration.
